(19) United States
(12) Patent Application Publication
(10) Pub. No.: US 2024/0353725 A1
(43) Pub. Date: Oct. 24, 2024

(54) DISPLAY PANEL AND DISPLAY DEVICE

(71) Applicants: Chongqing BOE Optoelectronics Technology Co., Ltd., Chongqing (CN); BOE Technology Group Co. Ltd., Beijing (CN)

(72) Inventors: Xiaoji LI, Beijing (CN); Yanli ZHAO, Beijing (CN); Zhe LI, Beijing (CN); Taeyup MIN, Beijing (CN); Xiaolin WANG, Beijing (CN); Zhifu DONG, Beijing (CN); Peng LI, Beijing (CN)

(21) Appl. No.: 18/685,306

(22) PCT Filed: Jun. 7, 2022
(86) PCT No.: PCT/CN2022/097460

§ 371 Date: Feb. 21, 2024

(51) Int. Cl. G02F 1/1368; G02F 1/1362

(52) U.S. Cl. CPC G02F 1/1368; G02F 1/136286

(57) ABSTRACT

The present disclosure provides a display panel and a display device. The display panel comprises: a first substrate, a plurality of first thin film transistors located on one side of the first substrate, and a first signal line located on one side of each first thin film transistor and insulated from each first thin film transistor; and a second substrate, and a plurality of first spacers located on the side of the second substrate facing the first substrate, the orthographic projection of each first spacer on the first substrate having an overlapping region with the orthographic projection of the first thin film transistor on the first substrate, and having an overlapping region with the orthographic projection of the first signal line on the first substrate.

### CROSS REFERENCE TO RELATED APPLICATIONS

This application is a national phase entry under 35 U.S.C. § 371 of International Application No. PCT/CN2022/097460, filed on Jun. 7, 2022, the entire content of which is incorporated herein by reference.

### FIELD

The disclosure relates to the field of display technology, in particular to a display panel and a display apparatus.

### BACKGROUND

Liquid crystal panels dominate the low-end market on account of its low cost. With the transmittance of the liquid crystal panels increased, cost of an optical film of a backlight module as well as an overall module will be lowered, and accordingly, the liquid crystal panels will become increasingly competitive.

Generally, the display panel is provided with a post spacer for supporting a liquid crystal cell and ensuring compression resistance under external force.

### SUMMARY

The disclosure provides a display panel and a display. The display panel includes: a first base substrate, a plurality of first thin-film transistors at a side of the first base substrate, and a first signal line at a side of the first thin-film transistor and insulated from the first thin-film transistor; a second base substrate, and a plurality of first post spacers at a side of the second base substrate facing the first base substrate. An orthographic projection of the first post spacer on the first base substrate has an overlapped area with an orthographic projection of the first thin-film transistor on the first base substrate, and has an overlapped area with an orthographic projection of the first signal line on the first base substrate.

In some embodiments, the display panel further includes, on the first base substrate, a data line and a touch line that extend in a first direction and are insulated from each other, and a gate line extending in a second direction, where the first direction intersects with the second direction; and the first signal line is the touch line.

In some embodiments, the first thin-film transistor includes a first gate electrode, a first active layer, and a first source and drain electrode that are stacked, the first source and drain electrode including a first source electrode integrally connected with the data line and a first drain electrode spaced from the first source electrode. An orthographic projection of a partial outer boundary of the first signal line on the first base substrate facing away from the first drain electrode is located within the orthographic projection of the first post spacer on the first base substrate.

In some embodiments, the display panel further includes at least one first elevation portion on the first base substrate, where an orthographic projection of the first elevation portion on the first base substrate has an overlapped area with the orthographic projection of the first signal line on the first base substrate, and has an overlapped area with the orthographic projection of the first post spacer on the first base substrate.

In some embodiments, the first elevation portion is a single film layer, or a composite structure including a plurality of film layers.

In some embodiments, the first elevation portion is located in an overlapped area of the gate line and the first signal line.

In some embodiments, the first elevation portion and the first active layer are located in the same layer and made from the same material.

In some embodiments, the first gate electrode protrudes from a side of the gate line close to the first drain electrode; and the first elevation portion and the first gate electrode are located at a same side of the gate line, and a gap is provided between the orthographic projections of the first elevation portion and the gate line on the first base substrate.

In some embodiments, the first gate electrode protrudes from two sides of the gate line in the first direction X; and the first elevation portions are distributed at two sides of the gate line, and a gap is provided between each of the orthographic projections of the first elevation portions at different sides and the gate line on the first base substrate.

In some embodiments, the first elevation portion comprises first floating metal and a first floating pattern at a side of the first floating metal facing away from the first base substrate; and the first floating metal and the first gate electrode are located in the same layer and made from the same material, and the first floating pattern and the first active layer are located in the same layer and made from the same material.

In some embodiments, an orthographic projection of the first floating metal on the first base substrate has a larger area than an orthographic projection of the first floating pattern on the first base substrate, and the orthographic projection of the first floating metal on the first base substrate covers the orthographic projection of the first floating pattern on the first base substrate.

In some embodiments, the display panel further includes a plurality of second thin-film transistors located on the first base substrate and a second elevation portion at a side of the second thin-film transistor. The display panel further includes a plurality of second post spacers at the side of the second base substrate facing the first base substrate, and an orthographic projection of the second post spacer on the first base substrate has an overlapped area with an orthographic projection of the second thin-film transistor on the first base substrate, and has an overlapped area with an orthographic projection of the second elevation portion on the first base substrate.

In some embodiments, the second thin-film transistor includes a second gate electrode, a second active layer, and a second source and drain electrode that are stacked, the second source and drain electrode including a second source electrode integrally connected with the data line and a second drain electrode spaced from the second source electrode; and the second elevation portion and the second drain electrode are located at different sides of the data line.

In some embodiments, the orthographic projection of the second elevation portion on the first base substrate is located within an orthographic projection of the second gate electrode on the first base substrate.

In some embodiments, the second elevation portion includes second floating metal, and the second floating metal and the second source and drain electrode are located in the same layer and made from the same material.

In some embodiments, the second elevation portion further includes a second floating pattern, and the second floating pattern and the second active layer are located in the same layer and made from the same material.

In some embodiments, an edge of the second source electrode facing away from the second drain electrode is a straight line, and an outer boundary of the second elevation portion facing the second source electrode is a straight line.

In some embodiments, a side of the second source electrode facing away from the second drain electrode is provided with a concave portion, and an outer boundary of the second elevation portion facing the second source electrode is provided with a convex portion.

In some embodiments, the orthographic projection of the second gate electrode on the first base substrate has an overlapped area with the orthographic projection of the second elevation portion on the first base substrate.

In some embodiments, the orthographic projection of the second elevation portion on the first base substrate is located within the orthographic projection of the second gate electrode on the first base substrate, and at least part of the orthographic projection of the second source electrode on the first base substrate is located within the orthographic projection of the second gate electrode on the first base substrate.

In some embodiments, a maximum length in the second direction of the orthographic projection of the first post spacer on the first base substrate is greater than a maximum length in the second direction of the orthographic projection of the second post spacer on the first base substrate, and a maximum length in the first direction of the orthographic projection of the first post spacer on the first base substrate is substantially equal to the maximum length in the first direction of the orthographic projection of the second post spacer on the first base substrate.

In some embodiments, the second post spacer includes a first sub-post spacer and a second sub-post spacer. A height of the first sub-post spacer in a direction perpendicular to the first base substrate is greater than a height of the second sub-post spacer in the direction perpendicular to the first base substrate, and the height of the first sub-post spacer in the direction perpendicular to the first base substrate is greater than a height of the first post spacer in the direction perpendicular to the first base substrate.

In some embodiments, the display panel includes a surface film layer on the first base substrate, where a distance between the surface film layer and the first base substrate is greater than a distance between the remaining film layers on the first base substrate and the first base substrate. A first gap is provided between the first post spacer and the surface film layer, a second gap is provided between the second sub-post spacer and the surface film layer, and the first sub-post spacer is in contact with the surface film layer.

In some embodiments, a length in the second direction of an orthographic projection of the first sub-post spacer on the first base substrate is smaller than a length in the second direction of an orthographic projection of the second sub-post spacer on the first base substrate.

In some embodiments, the orthographic projection of the first sub-post spacer on the first base substrate does not overlap an orthographic projection of the second drain electrode on the first base substrate.

In some embodiments, the second gate electrode and the first gate electrode are located in the same layer and made from the same material, the second active layer and the first active layer are located in the same layer and made from the same material, and the second source and drain electrode and the first source and drain electrode are located in the same layer and made from the same material.

In some embodiments, the display panel further includes a pixel electrode located on the first base substrate, where the pixel electrode is located between the first gate electrode and the first active layer; and the first drain electrode and the pixel electrode are in contact connection, and the second drain electrode and the pixel electrode are in contact connection.

In some embodiments, the display panel further includes a pixel electrode located on the first base substrate, where the pixel electrode is located at a side of the first source and drain electrode facing away from the first active layer; and the first drain electrode and the pixel electrode are in connection through a first via hole, and the second drain electrode and the pixel electrode are in connection through a second via hole.

In some embodiments, the display panel further includes a common electrode layer on the first base substrate, where the common electrode layer is reused as a touch electrode layer and has a plurality of touch electrode blocks that are insulated from each other; and the touch line and the touch electrode blocks are in connection in a one-to-one manner through via holes.

The embodiment of the disclosure further provides a display apparatus including the display panel according to the embodiment of the disclosure.

### BRIEF DESCRIPTION OF THE DRAWINGS

FIG. 1 is a schematic diagram of a section along the dotted line AB of FIG. 2A.

FIG. 2A is a first schematic diagram of a top view of a display panel according to an embodiment of the disclosure.

FIG. 2B is a schematic diagram of a single film layer including a gate line in FIG. 2A.

FIG. 2C is a schematic diagram of a single film layer including a first active layer in FIG. 2A.

FIG. 2D is a schematic diagram of a single film layer including a first source and drain electrode in FIG. 2A.

FIG. 2E is a schematic diagram of a single film layer including a first post spacer in FIG. 2A.

FIG. 2F is a schematic diagram of a single film layer of a black matrix in FIG. 2A.

FIG. 3 is a schematic diagram of a section at dotted line CD of FIG. 4A.

FIG. 4A is a second schematic diagram of a top view of a display panel according to an embodiment of the disclosure.

FIG. 4B is a schematic diagram of a single film layer including a gate line in FIG. 4A.

FIG. 4C is a schematic diagram of a single film layer including a first active layer in FIG. 4A.

FIG. 4D is a schematic diagram of a single film layer including a first source and drain electrode in FIG. 4A.

FIG. 4E is a schematic diagram of a single film layer including a first post spacer in FIG. 4A.

FIG. 4F is a schematic diagram of a single film layer of a black matrix in FIG. 4A.

FIG. 5 is a third schematic diagram of a top view of a display panel according to an embodiment of the disclosure.

FIG. 6A is a fourth schematic diagram of a top view of a display panel according to an embodiment of the disclosure.

FIG. 6B is a schematic diagram of a section at dotted line AB of FIG. 6A.

FIG. 6C is a schematic diagram of a single film layer including a gate line in FIG. 6A.

FIG. 6D is a schematic diagram of a single film layer including a first active layer in FIG. 6A.

FIG. 6E is a schematic diagram of a single film layer including a first source and drain electrode in FIG. 6A.

FIG. 6F is a schematic diagram of a single film layer including a first post spacer in FIG. 6A.

FIG. 6G is a schematic diagram of a single film layer of a black matrix in FIG. 6A.

FIG. 6H is a schematic diagram of a concave portion and a convex portion that have a shape of a rectangle.

FIG. 6I is a schematic diagram of a concave portion and a convex portion that have a shape of a triangle.

FIG. 6J is a schematic diagram of a concave portion and a convex portion that have a shape of a semicircle.

FIG. 6K is a schematic diagram of a concave portion and a convex portion that have a shape of an arc.

FIG. 6L is a schematic diagram of a concave portion and a convex portion that have a shape of a waveform.

FIG. 7A is a fifth schematic diagram of a top view of a display panel according to an embodiment of the disclosure.

FIG. 7B is a sixth schematic diagram of a top view of a display panel according to an embodiment of the disclosure.

FIG. 8A is a seventh schematic diagram of a top view of a display panel according to an embodiment of the disclosure.

FIG. 8B is a schematic diagram of a section at dotted line CD of FIG. 8A.

FIG. 8C is a schematic diagram of a single film layer including a gate line in FIG. 8A.

FIG. 8D is a schematic diagram of a single film layer including a first active layer in FIG. 8A.

FIG. 8E is a schematic diagram of a single film layer including a first source and drain electrode in FIG. 8A.

FIG. 8F is a schematic diagram of a single film layer including a first post spacer in FIG. 8A.

FIG. 8G is a schematic diagram of a single film layer of a black matrix in FIG. 8A.

FIG. 9A is an eighth schematic diagram of a top view of a display panel according to an embodiment of the disclosure.

FIG. 9B is a schematic diagram of a single film layer including a first source and drain electrode in FIG. 9A.

FIG. 10 is a schematic diagram of a top view of a touch electrode layer according to an embodiment of the disclosure.

FIG. 11 is a schematic diagram of an arrangement of a plurality of first post spacers, first sub-post spacers and second sub-post spacers when a first thin-film transistor T1 is an oxide thin-film transistor.

FIG. 12A is an enlarged view of the structure in dotted line box S1 in FIG. 11.

FIG. 12B is an enlarged view of the structure in dotted line box S2 in FIG. 11.

FIG. 13 is a schematic diagram of an arrangement of a first post spacer, a first sub-post spacer and a second sub-post spacer when a first thin-film transistor T1 is a polysilicon thin-film transistor.

FIG. 14A is an enlarged view of the structure in dotted line box S3 in FIG. 13.

FIG. 14B is an enlarged view of the structure in dotted line box S4 in FIG. 13.

### DETAILED DESCRIPTION

Technical solutions in some embodiments of the disclosure will be clearly and completely described below with reference to accompanying drawings. Apparently, the described embodiments are merely some embodiments rather than all embodiments of the disclosure. All other embodiments derived by a person of ordinary skill in the art based on the described embodiments of the disclosure shall fall within the protection scope of the disclosure.

Unless the context otherwise requires, throughout the description and the claims, the term “comprise” and its other forms, such as a third-person singular form “comprises” and a present participle form “comprising”, are interpreted as open and inclusive, that is, “include, but is not limited to”. In the text of the description, the terms such as “one embodiment”, “some embodiments”, “exemplary embodiments”, “example”, “specific example” or “some examples” are intended to indicate that specific features, structures, materials or specialties related to the embodiment or example are included in at least one embodiment or example of the disclosure. The schematic representations of the above terms do not necessarily refer to the same embodiment or example. Moreover, the described specific features, structures, materials or characteristics can be included in any one or more embodiments or examples in any suitable mode.

The terms “first” and “second” described below are merely used for describing purposes and cannot be understood as indicating or implying relative importance or implicitly indicating the number of indicated technical features. Therefore, the features defined with “first” and “second” can explicitly or implicitly include one or more features. In the description of the embodiment of the disclosure, unless otherwise specified, “plurality” means two or more.

In describing some embodiments, expressions of “electrical connection” and “connection” and their derivations may be used. For example, the term “point connection” can be used for describing some embodiments to indicate that two or more components are in direct physical contact or electrical contact with each other. The embodiments disclosed herein are not necessarily limited to the contents herein.

“A and/or B” includes three combinations as below: merely A, merely B, and a combination of A and B.

The use of “configured to” herein means openness and inclusiveness, which does not exclude devices suitable for or adaptable for performing additional tasks or steps.

In addition, the use of “based on” is open and inclusive since a process, step, calculation or other action “based on” one or more of the stated conditions or values can be based on additional conditions or exceed the stated values in practice.

As used herein, “approximately” or “substantially” includes a stated value and an average within an acceptable deviation range of a specific value which is determined by a person of ordinary skill in the art in consideration of the measurement in question and errors (i.e., limitations of a measurement system) related to the measurement of a specific quantity.

Exemplary implementation modes are described herein with reference to sectional views and/or plan views as idealized exemplary accompanying drawings. In the accompanying drawings, thicknesses of layers and regions are enlarged for clarity. Therefore, variations in shape relative to the accompanying drawings due to, for example, manufacturing technologies and/or tolerances are conceivable. Therefore, the exemplary implementation modes should not be interpreted as limited to shapes of the regions shown herein, but include shape deviations caused by, for example, manufacturing. For example, an etched region shown as a rectangle will generally have a curved feature. Therefore, the regions shown in the accompanying drawings are schematic in nature, and their shapes are not intended to show actual shapes of the regions of the device, and are not intended to limit the scope of the exemplary implementation modes.

In a liquid crystal display panel, a post spacer is usually placed below a black matrix of a color film substrate between two color resists and corresponding to a region of a thin-film transistor on an array substrate. For a mobile phone product, a post spacer will be placed for pixels each with a maximum contact density guaranteed. The contact density of the post spacer on the region of the thin-film transistor is usually a reference value to measure pressure resistance.

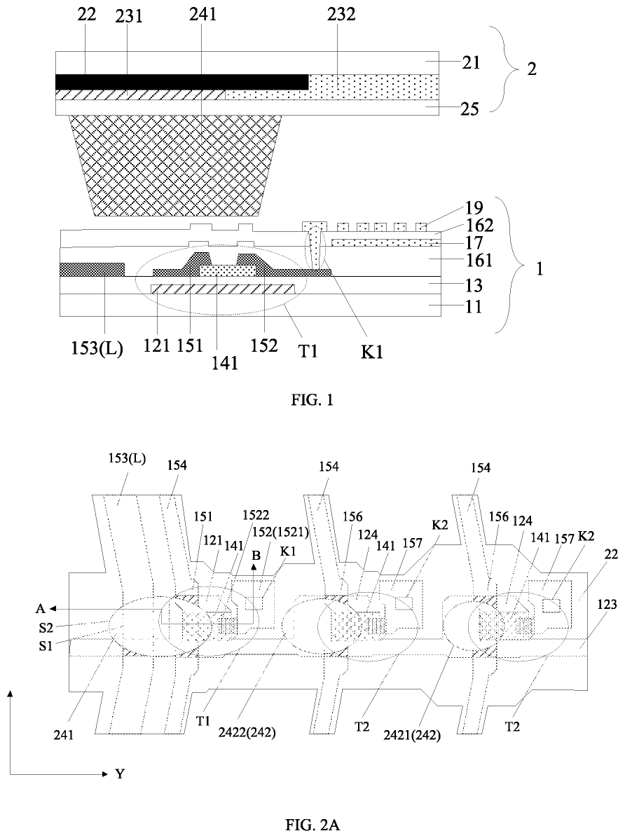

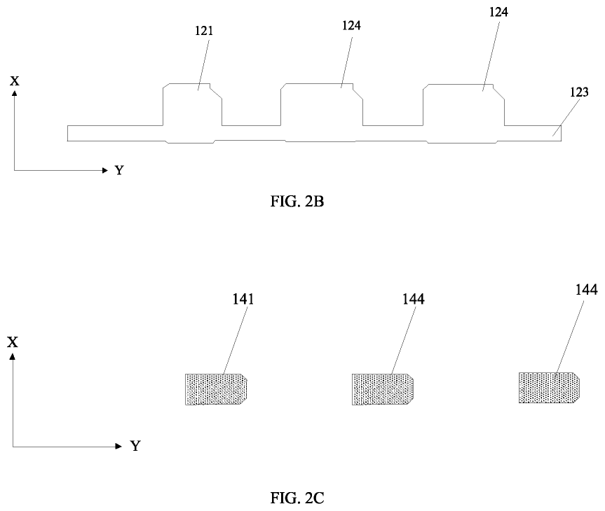

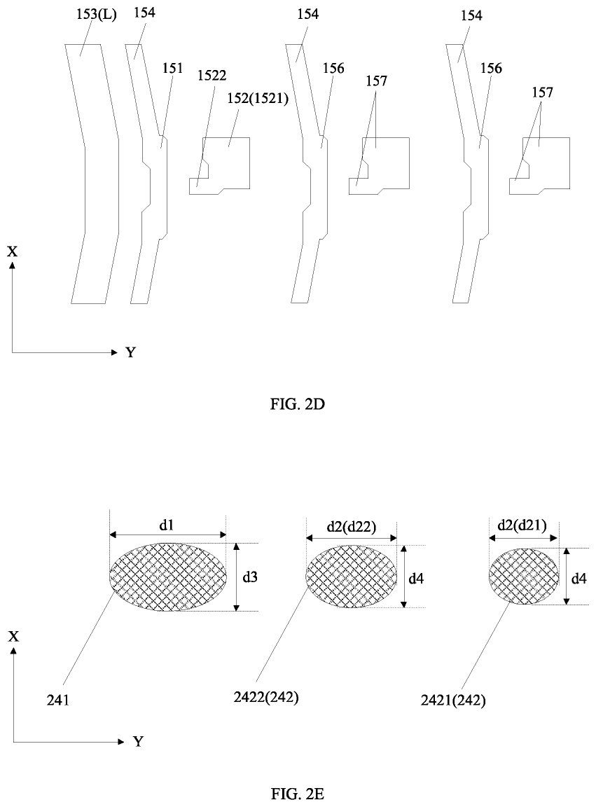

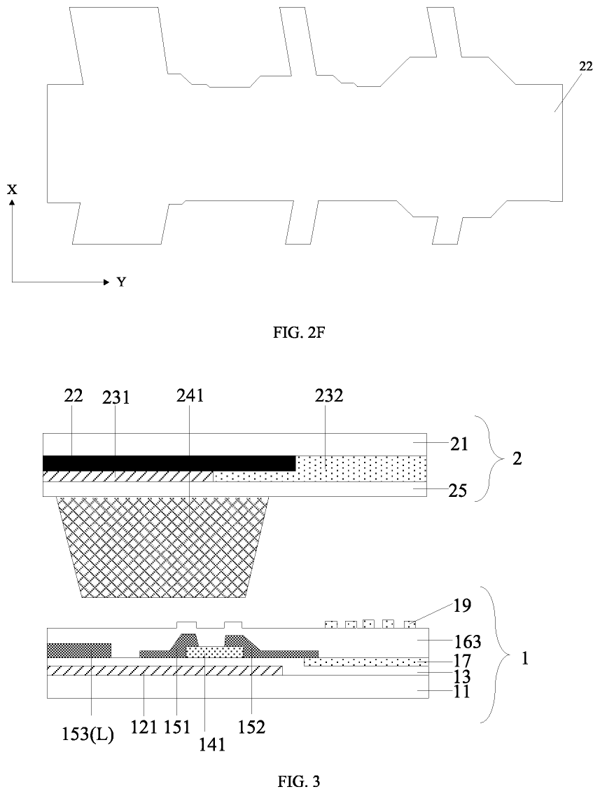

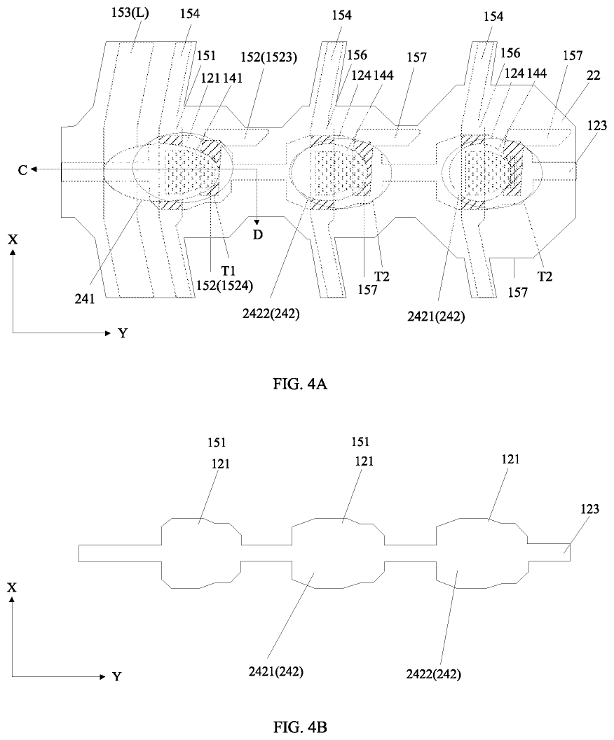

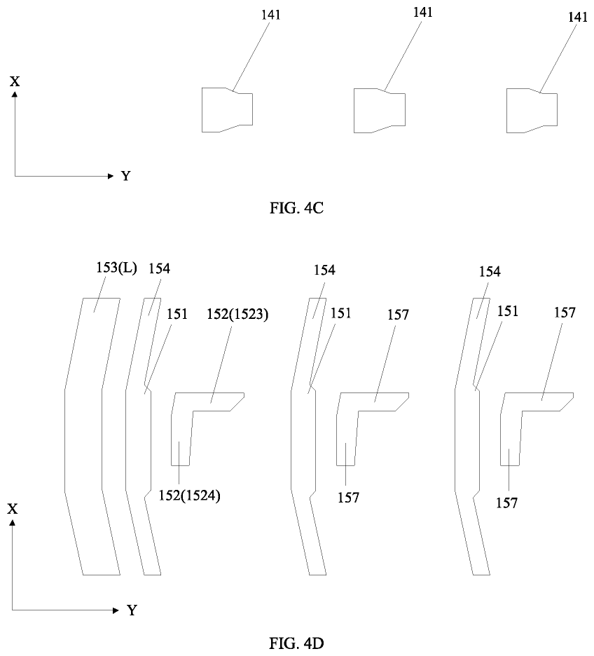

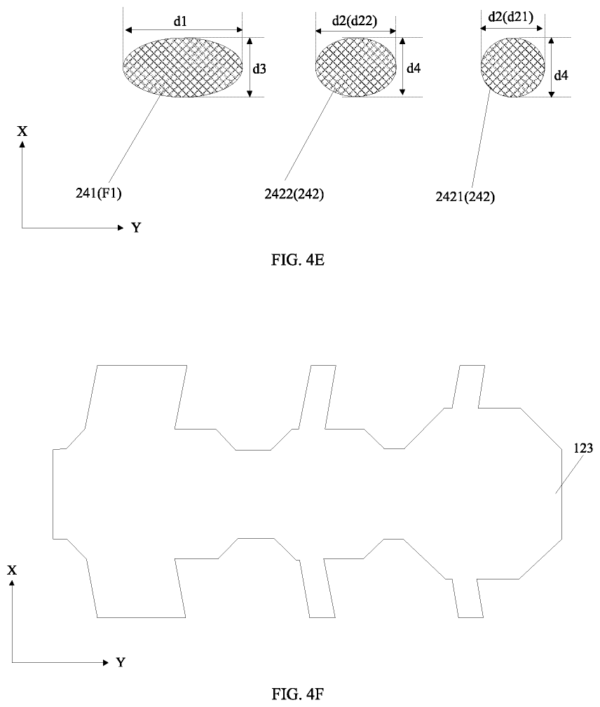

In view of this, as shown in FIGS. 1-4F, FIG. 1 is a schematic diagram of a section at dotted line AB of FIG. 2A, FIGS. 2B-2F are schematic diagrams of single film layers of film layers in FIG. 2A, FIG. 3 is a schematic diagram of a section at dotted line CD of FIG. 4A, and FIGS. 4B-4F are schematic diagrams of single film layers of film layers in FIG. 4A. Embodiments of the disclosure provide a display panel. The display panel includes:
a first base substrate 11, a plurality of first thin-film transistors T1 disposed at a side of the first base substrate 11, and a first signal line L disposed at a side of the first thin-film transistor T1 and insulated from the first thin-film transistor T1; specifically, the first base substrate 11 may be provided with the plurality of thin-film transistors, a thin-film transistor with the first signal line L around same may be the first thin-film transistor T1, and a thin-film transistor without the first signal line L around same may be the second thin-film transistor T2;
a second base substrate 21, a plurality of first post spacers 241 disposed at a side of the second base substrate 21 facing the first base substrate 11, and an orthographic projection of the first post spacer 241 on the first base substrate 11 has an overlapped area with an orthographic projection of the first thin-film transistor T1 on the first base substrate 11, and has an overlapped area with an orthographic projection of the first signal line L on the first base substrate 11.

In the embodiment of the disclosure, the orthographic projection of the first post spacer 241 on the first base substrate 11 has the overlapped area with the orthographic projection of the first thin-film transistor T1 on the first base substrate 11, and has the overlapped area with the orthographic projection of the first signal line L on the first base substrate 11. When the display panel is under pressure, a region of the first signal line L may also play a supporting role for the first post spacer 241, thereby improving compression resistance of the display panel without losing an aperture ratio.

In some embodiments, the display panel further includes, on the first base substrate 11, a data line 154 and a touch line 153 that extend in a first direction X and are insulated from each other, and a gate line 123 extending in a second direction Y, where the first direction X intersects with the second direction Y, and the first signal line L is the touch line 153. In the embodiment of the disclosure, the first signal line L is the touch line 153, and the touch line 153 already arranged on the display panel may be used as the first signal line L, and the first post spacer 241 is also arranged in the region of the first signal line L, such that the first signal line L is not needed to be manufactured separately, and therefore a manufacturing process of the display panel is simplified while the compression resistance of the display panel is improved.

During specific implementation, optionally, the first signal line L may be another signal line of the display panel, and a signal line that is arranged around the thin-film transistor and is insulated from the thin-film transistor may be used as the first signal line L. For example, in some embodiments, the first signal line L may also be a lead of a common electrode in the display panel.

In some embodiments, as shown in FIGS. 1-4F, the first thin-film transistor T1 includes a first gate electrode 121, a first active layer 141, and a first source and drain electrode that are stacked, the first source and drain electrode including a first source electrode 151 integrally connected with the data line 154 and a first drain electrode 152 spaced from the first source electrode 151; and an orthographic projection of a partial outer boundary S1 of the first signal line L far away from the first drain electrode 152 on the first base substrate 11 is located within the orthographic projection of the first post spacer 241 on the first base substrate 11. In some embodiments, for example, as shown in FIG. 2A, the orthographic projection of the partial outer boundary S1, far from the first drain electrode 152, of the first signal line L on the first base substrate 11 does not exceed an orthographic projection of an outer boundary S2, far from the first drain electrode 152, of the first post spacer 241 on the first base substrate 11. In the embodiment of the disclosure, the orthographic projection of the partial outer boundary S1, far away from the first drain electrode 152, of the first signal line L on the first base substrate 11 is located within the orthographic projection of the first post spacer 241 on the first base substrate 11, that is, in the second direction Y, the orthographic projection of the first post spacer 241 on the first base substrate 11 may cross the orthographic projection of the first signal line L on the first base substrate 11, thereby utilizing the region of the first signal line L to the maximum extent, and effectively supporting the first post spacer 241 under pressure to the greatest degree.

In some embodiments, as shown in FIG. 2A or FIG. 4A, the second thin-film transistor T2 includes a second gate electrode 124, a second active layer 144, and a second source and drain electrode that are stacked, the second source and drain electrode including a second source electrode 156 integrally connected with the data line 154 and a second drain electrode 157 spaced from the first source electrode 156.

As shown in FIGS. 1-4F, preferably, the first thin-film transistor T1 according to the embodiment of the disclosure may be a bottom-gate type thin-film transistor. During specific implementation, the first thin-film transistor according to the embodiment of the disclosure may optionally be a top-gate type thin-film transistor.

In some embodiments, as shown in FIGS. 1-2F, the thin-film transistor (including the first thin-film transistor T1) according to the embodiment of the disclosure may be an oxide transistor. The thin-film transistor in the form of an oxide thin-film transistor may have a small size, facilitating narrow bezel design of the display panel. In some embodiments, the active layer in the oxide transistor may be an oxide semiconductor, for example, the active layer may be made from indium gallium zinc oxide (IGZO).

In the case that the thin-film transistor according to the embodiment of the disclosure is the oxide thin-film transistor, a structure shown in FIGS. 1-2F will be further described in detail as follows.

The first active layer 141 may be disposed at a side of the first gate electrode 121 facing away from the first base substrate 11, the first source and drain electrode may be disposed at a side of the first active layer 141 facing away from the first gate electrode 121, and a gate insulation layer 13 may be provided between the first gate electrode 121 and the first active layer 141.

The display panel may further include a first passivation layer 161 at a side of the first source and drain electrode facing away from the first active layer 141, a first electrode 17 at a side of the first passivation layer 161 facing away from the first source and drain electrode, a second passivation layer 162 at a side of the first electrode 17 facing from the first passivation layer 161, and a second electrode 19 at a side of the second passivation layer 162 facing away from the first electrode 17. In some embodiments, the first electrode 17 may be a common electrode, the second electrode 19 may be a pixel electrode, and the first electrode 17 and the second electrode 19 may be made from indium tin oxide. The second electrode 19 may be electrically connected with the first drain electrode 152 through a via hole K1. At a position of the first thin-film transistor T1, the first drain electrode 152 and the pixel electrode (the second electrode 19) may be in connection through a first via hole K1, and at a position of the second thin-film transistor T2, the second drain electrode 157 and the pixel electrode (the second electrode 19) may be in connection through a second via hole K2.

In some embodiments, the first gate electrode 121 may protrude from a side of the gate line 123, for example, the first gate electrode 121 protrudes from a side of the gate line 123 close to the first drain electrode 152. The first drain electrode 152 includes a first body portion 1521 and an extension portion 1522 extending from the first body portion 1521 towards the first gate electrode 121. An orthographic projection of the first active layer 141 on the first base substrate 11 has an overlapped area with an orthographic projection of the first gate electrode 121 on the first base substrate 11. The orthographic projection of the first active layer 141 on the first base substrate 11 has an overlapped area with an orthographic projection of the extension portion 1522 on the first base substrate 11.

In some embodiments, the display panel may further include: a color film layer between the second base substrate 21 and the first post spacer 241. In some embodiments, the color film layer may include a blue color resist 231, a red color resist 232, and a green color resist (not shown in the figure). In some embodiments, as shown in FIG. 1, an orthographic projection of the first post spacer 241 on the second base substrate 21 has an overlapped area with an orthographic projection of the blue color resist 231 on the second base substrate 21, and has an overlapped area with an orthographic projection of the red color resist 232 on the second base substrate 21. Of course, in some possible implementation modes, the orthographic projection of the first post spacer 241 on the second base substrate 21 has the overlapped area with the orthographic projection of the blue color resist 231 on the second base substrate 21, and has an overlapped area with an orthographic projection of the green color resist on the second base substrate 21. In some other possible embodiments, the orthographic projection of the first post spacer 241 on the second base substrate 21 has the overlapped area the orthographic projection of the red color resist 232 on the second base substrate 21, and has the overlapped area with the orthographic projection of the green color resist on the second base substrate 21. The black matrix 22 may be further arranged between the color film layer and the second base substrate 21, and an optical adhesive layer 25 may be further arranged at a side of the color film layer facing away from the second base substrate 21. The first base substrate 11 and film layers on the first base substrate 11 may form a first substrate 1, and the second base substrate 21 and film layers on the second base substrate 21 may form a second substrate 2. In some embodiments, the first substrate 1 may be an array substrate, and the second base substrate 2 may be a color film substrate.

In some embodiments, as shown in FIG. 3-4F, the thin-film transistor (including the first thin-film transistor T1) according to the embodiment of the disclosure may be a polysilicon transistor.

In the case that the thin-film transistor according to the embodiment of the disclosure is the polysilicon thin-film transistor, a structure shown in FIGS. 3-4F will be further described in detail as follows.

The first active layer 141 may be disposed at a side of the first gate electrode 121 facing away from the first base substrate 11, the first source and drain electrode may be disposed at a side of the first active layer 141 facing away from the first gate electrode 121, and a gate insulation layer 13 may be arranged between the first gate electrode 121 and the first active layer 141.

The display panel may further include a first electrode 17 between the gate insulation layer 13 and the first active layer 141, a third passivation layer 163 at a side of the first source and drain electrode facing away from the first active layer 141, and a second electrode 19 at a side of the third passivation layer 163 facing away from the first source and drain electrode. In some embodiments, the first electrode 17 may be a pixel electrode, the second electrode 19 may be a common electrode, and the first electrode 17 and the second electrode 19 may be made from indium tin oxide. The first electrode 17 may be the pixel electrode to be in direct contact with the first drain electrode 152.

In some embodiments, the first gate electrode 121 may protrude from two sides of the gate line 123. For example, the first gate electrode 121 protrudes from two sides of the gate line 123 in a first direction X. The first drain electrode 152 includes: a third body portion 1523 extending in the first direction X, and a fourth body portion 1524 that is connected with an end of the third body portion 1523 and extends in a second direction Y. An orthographic projection of the first active layer 141 on the first base substrate 11 has an overlapped area with an orthographic projection of the first gate electrode 121 on the first base substrate 11. The orthographic projection of the first active layer 141 on the first base substrate 11 has an overlapped area with an orthographic projection of the fourth body portion 1524 on the first base substrate 11. In the first direction X, an orthographic projection of the first post spacer 241 on the first base substrate 11 has an overlapped area with the orthographic projection of the fourth body part 1524 on the first base substrate 11, and the orthographic projection of the first post spacer 241 on the first base substrate 11 and the orthographic projection of the third body portion 1523 on the first base substrate 11 do not overlap each other.

In some embodiments, the display panel may further include: a color film layer between the second base substrate 21 and the first post spacer 241. In some embodiments, the color film layer may include a blue color resist 231, a red color resist 232, and a green color resist (not shown in the figure). In some embodiments, as shown in FIG. 3, an orthographic projection of the first post spacer 241 on the second base substrate 21 has an overlapped area with an orthographic projection of the blue color resist 231 on the second base substrate 21, and has an overlapped area with an orthographic projection of the red color resist 232 on the second base substrate 21. Of course, in some possible implementation modes, the orthographic projection of the first post spacer 241 on the second base substrate 21 has the overlapped area with the orthographic projection of the blue color resist 231 on the second base substrate 21, and has an overlapped area with an orthographic projection of the green color resist on the second base substrate 21. In some other possible embodiments, the orthographic projection of the first post spacer 241 on the second base substrate 21 has the overlapped area the orthographic projection of the red color resist 232 on the second base substrate 21, and has the overlapped area with the orthographic projection of the green color resist on the second base substrate 21. The black matrix 22 may be further arranged between the color film layer and the second base substrate 21, and an optical adhesive layer 25 may be further arranged at a side of the color film layer far from the second base substrate 21. The first base substrate 11 and film layers on the first base substrate 11 may form a first substrate 1, and the second base substrate 21 and film layers on the second base substrate 21 may form a second substrate 2. In some embodiments, the first base substrate 1 may be an array substrate, and the second base substrate 2 may be a color film substrate.

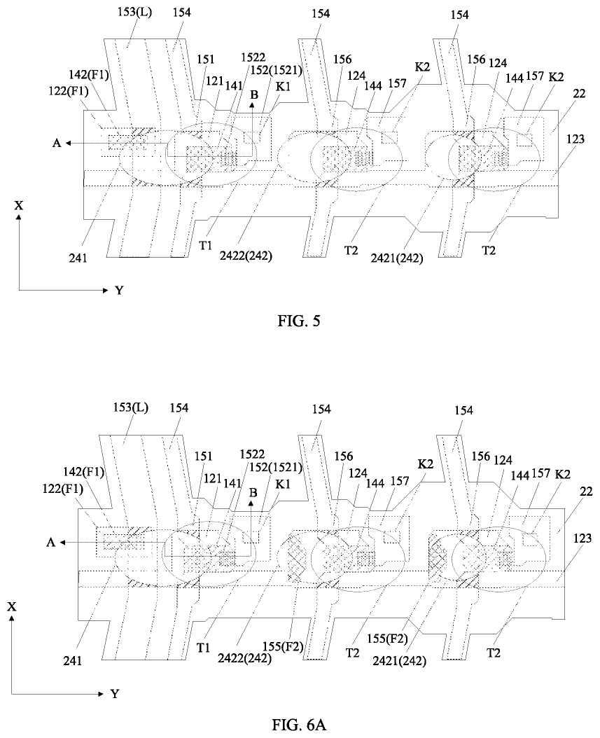

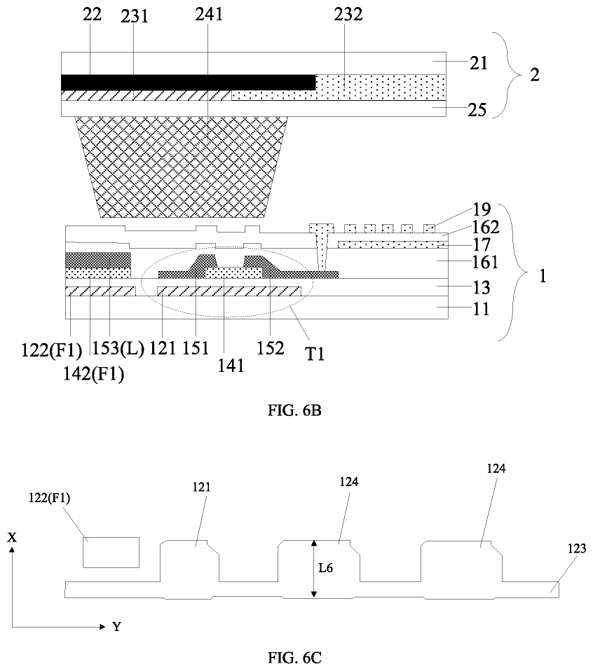

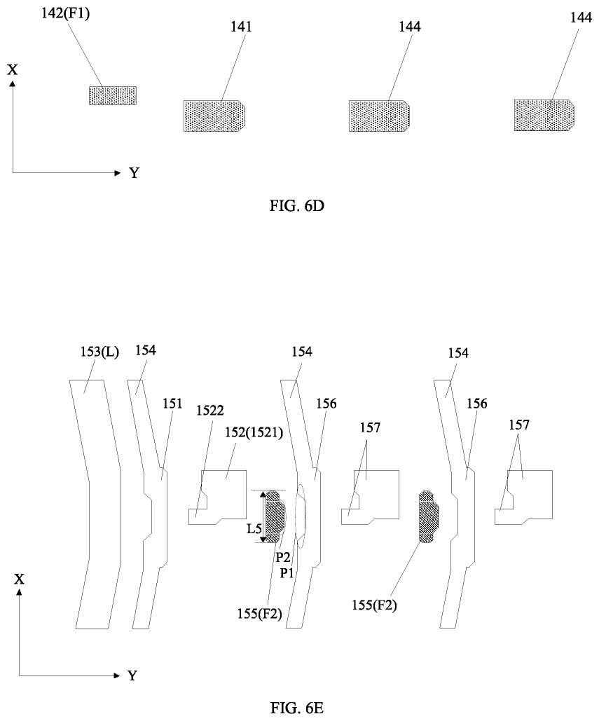

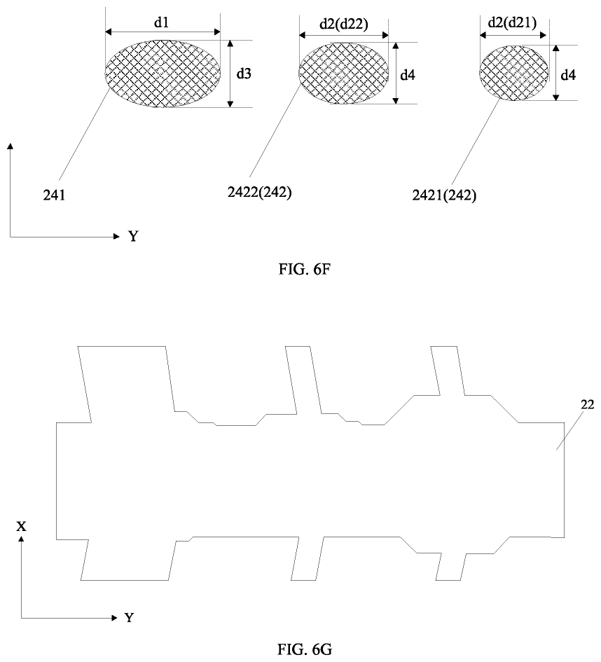

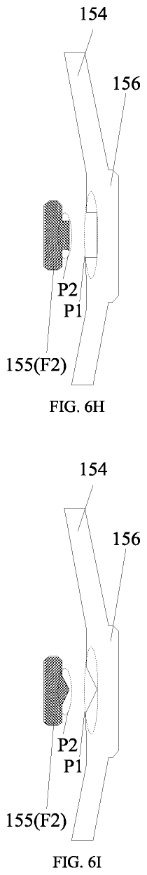

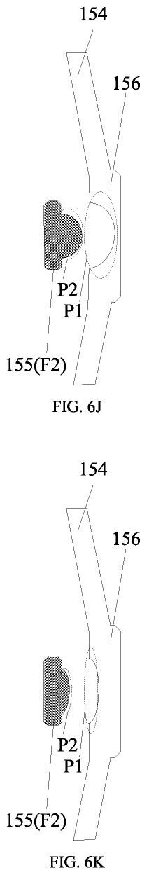

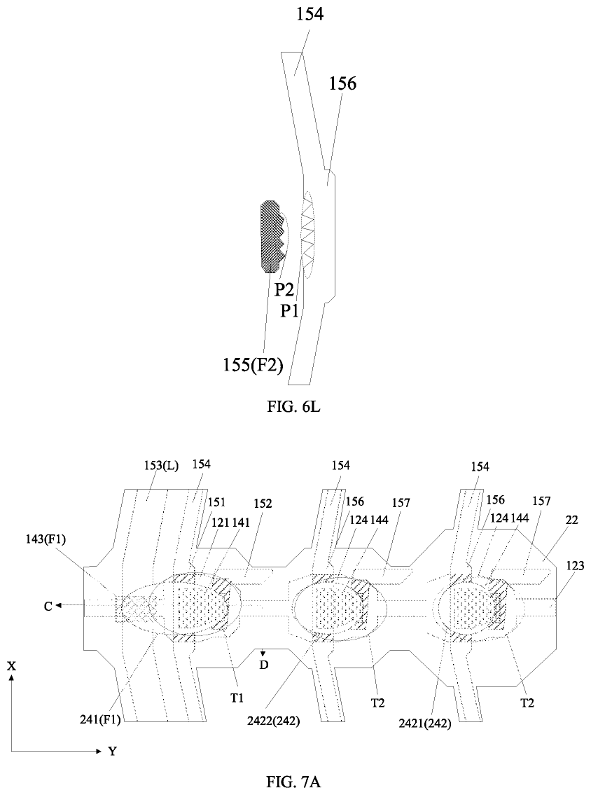

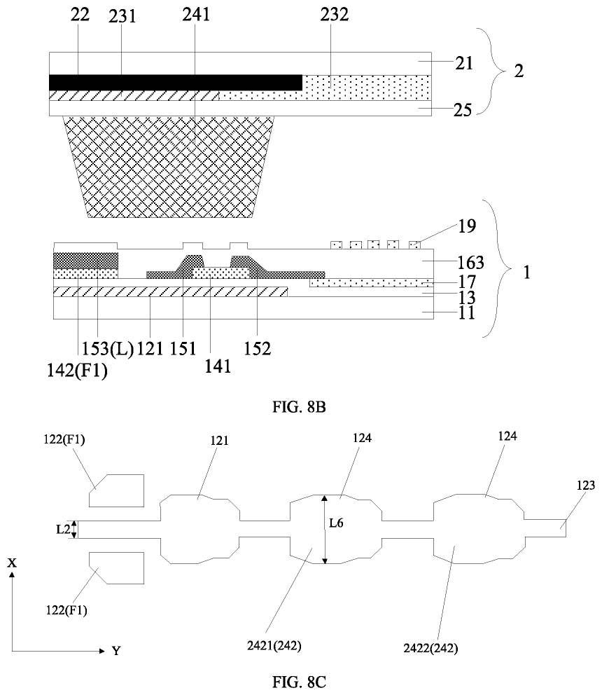

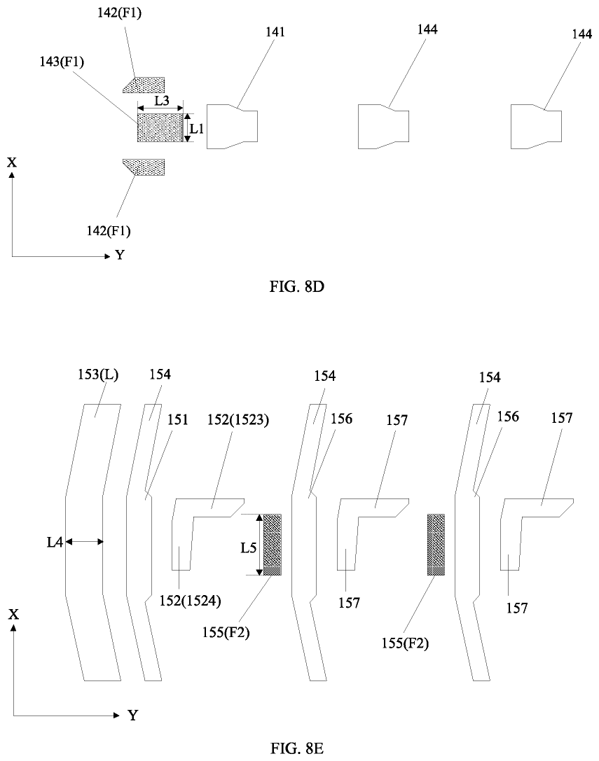

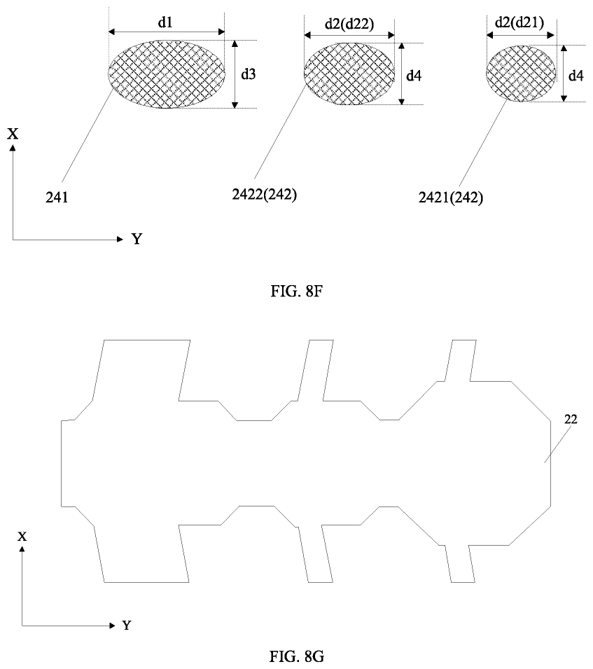

In some embodiments, as shown in FIGS. 5-8F, FIG. 6B is a schematic diagram of a section at dotted line AB of FIG. 6A, FIGS. 6C-6G are schematic diagrams of single film layers of film layers in FIG. 6A, FIG. 8B is a schematic diagram of a section at dotted line CD of FIG. 8A, and FIGS. 8C-8G are schematic diagrams of single film layers of film layers in FIG. 8A. The display panel further includes at least one first elevation portion F1 disposed on the first base substrate 11, where an orthographic projection of the first elevation portion F1 on the first base substrate 11 has an overlapped area with an orthographic projection of the first signal line L on the first base substrate 11, and has an overlapped area with the orthographic projection of the first post spacer 241 on the first base substrate. In this way, when the display panel is under pressure, a region of the first elevation portion F1 may also play a supporting role for the first post spacer 241, thereby further improving compression resistance of the display panel without losing an aperture ratio.

During specific implementation, the first elevation portion F1 may be a single film layer or have a composite structure including a plurality of film layers. The display panel may be provided with one first elevation portion F1, two first elevation portions F1, three first elevation portions F1 or more first elevation portions F1. The first elevation portion F1 may be flexibly set in position as required, which will be described in detail as follows.

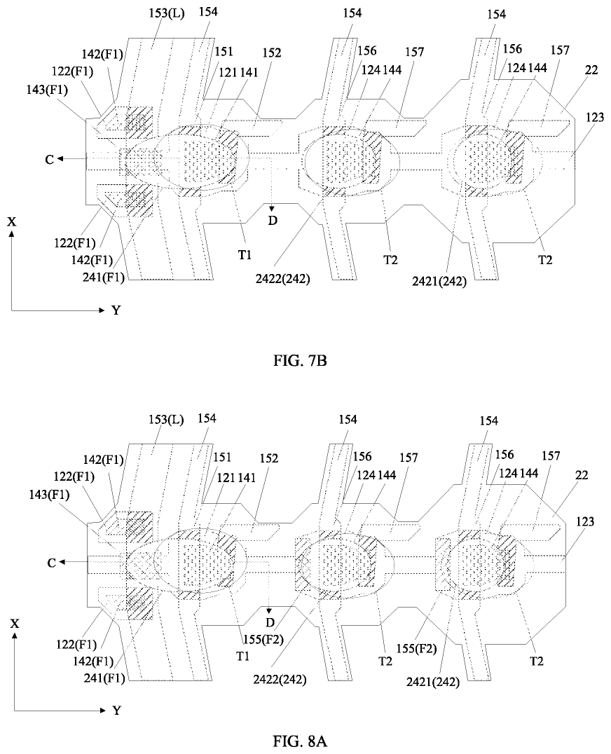

In some embodiments, as shown in FIG. 7A, the first elevation portion 143(F1) is located in an overlapped area of the gate line 123 and the first signal line L. In some embodiments, the first elevation portion 143(F1) and the first active layer 141 are located in the same layer and made from the same material. In the embodiment of the disclosure, since a region of the first thin-film transistor T1 is provided with the first active layer 141, the overlapped area of the gate line 123 and the first signal line L is provided with the first elevation portion 143(F1), and the first elevation portion 143(F1) and the first active layer 141 are located in the same layer and made from the same material, the region of the first thin-film transistor T1 may have substantially the same height as the overlapped area of the gate line 123 and the first signal line L, further, gaps between the first post spacer 241 and an uppermost film layer of the first base substrate 1 may be consistent, and the first post spacer 241 may be supported evenly in a height direction. In addition, the first elevation portion 143(F1) and the first active layer 141 are located in the same layer and made from the same material, such that the first elevation portion 143(F1) may be formed while the first active layer 141 is formed, and a manufacturing process of the display panel may be simplified under the condition of satisfying the requirement that the region of the first thin-film transistor T1 has substantially the same height as the overlapped area of the gate line 123 and the first signal line L.

In some embodiments, as shown in FIG. 7A, an orthographic projection of the first elevation portion 143(F1) on the first base substrate 11 may be similar to an orthographic projection of the overlapped area of the gate line 123 and the first signal line L on the first base substrate 11 in shape. For example, in the case that the orthographic projection of the overlapped area of the gate line 123 and the first signal line L on the first base substrate 11 has a shape of a rectangle, the orthographic projection of the first elevation portion 143(F1) on the first base substrate 11 also has a shape of a rectangle. In some embodiments, as shown in FIGS. 8B, 8C and 8D, in the first direction X, a length L1 of the first elevation portion 143(F1) is greater than a length L2 of the gate line 123. In the second direction Y, a length L3 of the first elevation portion 143(F1) is greater than a length L4 of the first signal line L.

It should be noted that the embodiment of the disclosure is merely a schematic description of arranging the first elevation portion F1 in the overlapped area of the gate line 123 and the first signal line L, by taking the first thin-film transistor T1 shown in FIG. 7A as a polysilicon thin-film transistor. During specific implementation, in the case that the first thin-film transistor T1 is an oxide thin-film transistor, the first elevation portion F1 may be arranged in the overlapped area of the gate line 123 and the first signal line L, and the first elevation portion 143(F1) and the first active layer 141 may be located in the same layer and made from the same material.

In some embodiments, in the case that the first thin-film transistor T1 is in a structure of the oxide thin-film transistor, as shown in FIGS. 5-6G, the first gate electrode 121 protrudes from the side of the gate line 123 close to the drain 152. The first elevation portions 122(F1)/142(F1) and the first gate electrode 121 are located at the same side as the gate line 123, and a gap is provided between the orthographic projection of the first elevation portion 122(F1)/142(F1) on the first base substrate 11 and the gate line 123. In some embodiments, as shown in FIGS. 5-6G, the first elevation portion F1 includes first floating metal 122 and a first floating pattern 142 at a side of the first floating metal 122 facing away from the first base substrate 11; and the first floating metal 122 and the first gate electrode 121 are located in the same layer and made from the same material, and the first floating pattern 142 and the first active layer 141 are located in the same layer and made from the same material. In the embodiment of the disclosure, when the first post spacer 241 extends over the first signal line L in the first direction X, a region of the orthographic projection of the first post spacer 241 on the first base substrate 11 has both the first gate electrode 121 and the first active layer 141 in the region of the first thin-film transistor T1. By arranging, in a region of the first signal line L, the first elevation portion 122(F1)/142(F1) at the same side of the gate line 123 as the first gate electrode 121, the first post spacer 241 may be supported at two sides of the first post spacer 241 in the first direction X, thus achieving balanced support, and avoiding the condition that the region of the first thin-film transistor T1 is higher than the region of the first signal line L, when the display panel is under pressure, the first post spacer 241 may not be effectively supported due to inconsistent height. In addition, the first floating metal 122 and the first gate electrode 121 are located in the same layer and made from the same material, and the first floating pattern 142 and the first active layer 141 are located in the same layer and made from the same material, such that the manufacturing process of the display panel may be simplified under the condition of satisfying the requirement that the region of the first thin-film transistor T1 has substantially the same height as the region of the first signal line L.

In addition, the gap is provided between the orthographic projection of the first elevation portion 122(F1)/142(F1) on the first base substrate 11 and the gate line 123. The first elevation portion 122(F1)/142(F1) includes the first floating metal 122 and the first floating pattern 142 at the side of the first floating metal 122 facing away from the first base substrate 11; and the first floating metal 122 and the first gate electrode 121 are located in the same layer and made from the same material, and the first floating pattern 142 and the first active layer 141 are located in the same layer and made from the same material. Since a gap is provided between the first floating metal 122 and the gate line 123 that thus they are unconnected, in actual use, no signal is loaded, the compression resistance of the display panel may be improved without increasing loads of the gate line 123 and the first signal line L.

In some embodiments, in the case that the first thin-film transistor T1 is in a structure of the polysilicon thin-film transistor, as shown in FIGS. 7B-8G, the first gate electrode 121 protrudes from two sides of the gate line 123 in the first direction X. The first elevation portions 122(F1)/142(F1) are distributed on two sides of the gate line 123, and a gap is provided between each of the orthographic projections of the first elevation portions 122(F1)/142(F1) of different sides on the first base substrate 11 and the gate line 123. In some embodiments, as shown in FIGS. 7B-8G, the first elevation portion 122(F1)/142(F1) includes first floating metal 122 and a first floating pattern 142 at a side of the first floating metal 122 facing away from the first base substrate 11; and the first floating metal 122 and the first gate electrode 121 are located in the same layer and made from the same material, and the first floating pattern 142 and the first active layer 141 are located in the same layer and made from the same material. In the embodiment of the disclosure, since the first gate electrode 121 protrudes from the two sides of the gate line 123 in the first direction X, and the first elevation portions 122(F1)/142(F1) are distributed on two sides of the gate line 123, when the display panel is under pressure, after the first post spacer 241 shifts at a pressed position, the first elevation portions 122(F1)/142(F1) at the two sides may provide effective support. In addition, the first floating metal 122 and the first gate electrode 121 are located in the same layer and made from the same material, and the first floating pattern 142 and the first active layer 141 are located in the same layer and made from the same material, thereby simplifying a manufacturing process of the display panel.

In addition, the first gate electrode 121 protrudes from the two sides of the gate line 123 in the first direction X, and the gap is provided between each of the orthographic projections of the first elevation portions F1 of different sides on the first base substrate 11 and the gate line 123. The first elevation portion 122(F1)/142(F1) includes the first floating metal 122 and the first floating pattern 142 at the side of the first floating metal 122 facing away from the first base substrate 11; and the first floating metal 122 and the first gate electrode 121 are located in the same layer and made from the same material, and the first floating pattern 142 and the first active layer 141 are located in the same layer and made from the same material. Since a gap is provided between an orthographic projection of the first floating metal 122 of different sides on the first base substrate 11 and the gate line 123, there is no connection between them, and no signal is loaded by the first floating metal 122 in actual use, the compression resistance of the display panel may be improved without increasing loads of the gate line 123 and the first signal line L.

In some embodiments, as shown in FIGS. 6A and 8A, the orthographic projection of the first floating metal 122 on the first base substrate 11 has a larger area than the orthographic projection of the first floating pattern 142 on the first base substrate 11, and the orthographic projection of the first floating metal 122 on the first base substrate 11 covers the orthographic projection of the first floating pattern 142 on the first base substrate 11. In some embodiments, the orthographic projection of the first floating metal 122 on the first base substrate 11 is located in a region of an orthographic projection of a black matrix 22 on the first base substrate 11, and the orthographic projection of the first floating pattern 142 on the first base substrate 11 is located in the region of the orthographic projection of the black matrix 22 on the first base substrate 11, such that the compression resistance of the display panel may be improved without affecting the aperture ratio of the display panel.

In some embodiments, as shown in FIGS. 6A, 8A and 9A, the display panel further includes a second elevation portion F2 at a side of a second thin-film transistor T2. The display panel further includes a plurality of second post spacers 242 located at a side of the second base substrate 21 facing the first base substrate 11, and an orthographic projection of the second post spacer 242 on the first base substrate 11 has an overlapped area with an orthographic projection of the second thin-film transistor T2 on the first base substrate 11, and has an overlapped area with an orthographic projection of the second elevation portion F2 on the first base substrate 11. In the embodiment of the disclosure, the display panel further includes the second elevation portion F2 at the side of the second thin-film transistor T2, the orthographic projection of the second post spacer 242 on the first base substrate 11 has the overlapped area with the orthographic projection of the second thin-film transistor T2 on the first base substrate 11, and has an overlapped area with the orthographic projection of the second elevation portion F2 on the first base substrate 11. When the display panel is under pressure, a region of the second elevation portion F2 may also play a supporting role for the second post spacer 242, thereby improving compression resistance of the display panel without losing an aperture ratio.

In some embodiments, as shown in FIGS. 6A, 8A and 9A, the second elevation portion F2 and a second drain electrode 157 of the second thin-film transistor T2 are located at different sides of the data line 154. In this way, a left side and a right side of the second post spacer 242 may be supported in a balanced mode in the second direction Y.

In some embodiments, as shown in FIGS. 6A, 8A and 9A, the orthographic projection of the second elevation portion F2 on the first base substrate 11 is located within the orthographic projection of the second gate electrode 124 on the first base substrate 11, specifically, in the case that the orthographic projection of the second elevation portion F2 on the first base substrate 11 is located within the orthographic projection of the second gate electrode 124 on the first base substrate 11. The orthographic projection of the second elevation portion F2 on the first base substrate 11 may be understood to be located within an orthographic projection of the second gate electrode 124 and partial gate line 123 connected with the second gate electrode 124 on the first base substrate 11. In some embodiments, as shown in FIGS. 6C-6G and 8C-8G, the length L5 of the second elevation portion F2 in the first direction X may be substantially the same as the length L6 of the second gate electrode 124 in the first direction X. It may be understood that in an actual manufacturing process, due to process limitation, a requirement that the length L5 of the second elevation portion F2 in the first direction X and the length L6 of the second gate electrode 124 in the first direction X are completely the same is technically difficult to achieve. Furthermore, in the embodiment of the disclosure, the length L5 of the second elevation portion F2 in the first direction X and the length L6 of the second gate electrode 124 in the first direction X are substantially the same, which may be understood as the ratio of a difference thereof to either length smaller than 10%.

In some embodiments, as shown in FIGS. 6A, 8A and 9A, the second elevation portion F2 includes second floating metal 155, and the second floating metal 155 and the second source and drain electrode are located in the same layer and made from the same material. In the embodiment of the disclosure, the second elevation portion F2 includes the second floating metal 155, and the second floating metal 155 and the second source and drain electrode are located in the same layer and made from the same material, such that the manufacturing process of the display panel may be simplified under the condition of satisfying the requirement that a region of the second thin-film transistor T2 has substantially the same height as a region of the second elevation portion F2.

In some embodiments, similar to a formation mode of the first elevation portion F1, the second elevation portion F2 further includes a second floating pattern (not shown in the figure), and the second floating pattern and the second active layer 144 may be in the same layer and made from the same material.

In some embodiments, as shown in FIGS. 6A-6L, a side of the second source electrode 156 facing away from the second drain electrode 157 is provided with a concave portion P1, and an outer boundary of the second elevation portion F2 facing the second source electrode 156 is provided with a convex portion P2. In the embodiment of the disclosure, the side of the second source electrode 156 facing away from the second drain electrode 157 is provided with the concave portion P1, such that an overlapped area of the data line 154 and the gate line 123 and/or the gate 124 may be reduced, parasitic capacitance of the data line 154 and the gate line 123 and/or the gate electrode 124 may be reduced accordingly. In the case that the side of the second source electrode 156 facing away from the second drain electrode 157 is provided with the concave portion P1 of the second elevation portion F2 the outer boundary, facing the second source electrode 156 is provided with the convex portion P2, such that the orthographic projection area of the second elevation portion F2 on the first base substrate 11 may have a larger area while the second elevation portion F2 and the data line 154 are guaranteed to be insulated from each other, and the second post spacer 242 may be effectively supported.

During specific implementation, an orthographic projection of the concave portion P1 on the first base substrate 11 may be similar to an orthographic projection of the convex portion P2 on the first base substrate 11 in shape. In some embodiments, the orthographic projection of the concave portion P1 on the first base substrate 11 may have a shape of a trapezoid, as shown in FIG. 6E. In other embodiments, the orthographic projection of the concave portion P1 on the first base substrate 11 may have a shape of a rectangle, as shown in FIG. 6H. In some other embodiments, the orthographic projection of the concave portion P1 on the first base substrate 11 may also have a shape of a triangle, as shown in FIG. 6I. In some other embodiments, the orthographic projection of the concave portion P1 on the first base substrate 11 may also have a shape of a semicircle, as shown in FIG. 6J. In some other embodiments, the orthographic projection of the concave portion P1 on the first base substrate 11 may also have a shape of an arc as shown in FIG. 6K. In some other embodiments, the orthographic projection of the concave portion P1 on the first base substrate 11 may also have a shape of a waveform, as shown in FIG. 6L. In some embodiments, the orthographic projection of the convex portion P2 on the first base substrate 11 may have a shape of a trapezoid, as shown in FIG. 6E. In other embodiments, the orthographic projection of the convex portion P2 on the first base substrate 11 may have a shape of a rectangle, as shown in FIG. 6H. In some other embodiments, the orthographic projection of the convex portion P2 on the first base substrate 11 may also have a shape of a triangle, as shown in FIG. 6I. In some other embodiments, the orthographic projection of the convex portion P2 on the first base substrate 11 may also have a shape of a semicircle, as shown in FIG. 6J. In some other embodiments, the orthographic projection of the convex portion P2 on the first base substrate 11 may also have a shape of an arc, as shown in FIG. 6K. In some other embodiments, the orthographic projection of the convex portion P2 on the first base substrate 11 may also have a shape of a waveform, as shown in FIG. 6L.

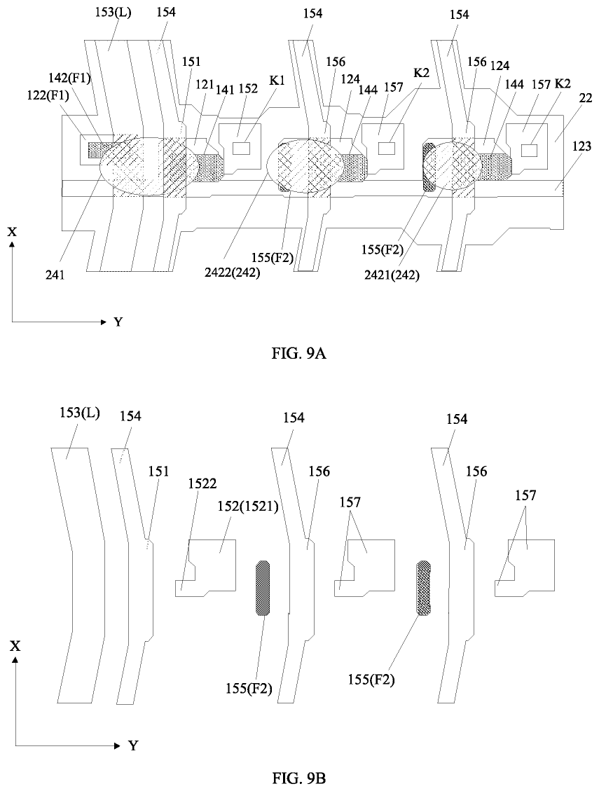

In some embodiments, as shown in FIGS. 9A-9B and FIGS. 8A-8G, an edge of the second source electrode 156 facing away from the second drain electrode 157 may be a straight line, and the outer boundary of the second elevation portion F2 facing the second source electrode 156 may be a straight line.

In some embodiments, as shown in FIGS. 5-8G, the orthographic projection of the second gate electrode 124 on the first base substrate 11 has an overlapped area with the orthographic projection of the second elevation portion F2 on the first base substrate 11.

In some embodiments, as shown in FIGS. 5-8G, the orthographic projection of the second elevation portion F2 on the first base substrate 11 is located within the orthographic projection of the second gate electrode 124 on the first base substrate 11, and at least part of the orthographic projection of the second source electrode 156 on the first base substrate 11 is located within the orthographic projection of the second gate electrode 124 on the first base substrate 11.

In some embodiments, the first post spacer 241 and the second post spacer 242 may be similar in shape. In some embodiments, the first post spacer 241 may have a shape of a frustum, and the second post spacer 242 may have a shape of a frustum. In some embodiments, each of the frustum-shaped first post spacer 241 and the frustum-shaped second post spacer 242 may have a top surface facing the first base substrate 11 and a bottom surface facing the second base substrate 21, and the top surface has a smaller area than the bottom surface. In the embodiment of the disclosure, the orthographic projection of the first post spacer 241 on the first base substrate 11 and the orthographic projection the second post spacer 242 on the first base substrate may be understood as the top surface of the first post spacer 241 on the first base substrate 11 and the top surface of the second post spacer 242 on the first base substrate.

In some embodiments, as shown in FIGS. 2A-2F, FIGS. 4A-4F, FIGS. 6A-6F and FIGS. 8A-8F, the orthographic projection of the first post spacer 241 on the first base substrate 11 may be similar to the orthographic projection of the second post spacer 242 on the first base substrate 11 in shape. In some embodiments, the orthographic projection of the first post spacer 241 on the first base substrate 11 may have a shape of an ellipse or a circle, and the orthographic projection of the second post spacer 242 on the first base substrate 11 may have a shape of an ellipse or a circle, as shown in FIG. 2D, 4E, 6E or 8E. In some other embodiments, the orthographic projection shape of the first post spacer 241 on the first base substrate 11 may have a shape of a quadrilateral, a pentagon, a hexagon or an octagon.

In some embodiments, as shown in FIGS. 2A-2F, FIGS. 4A-4F, FIGS. 6A-6G and FIGS. 8A-8G, a maximum length d1 in the second direction Y of an orthographic projection of the first post spacer 241 on the first base substrate 11 is greater than a maximum length d2 in the second direction Y of an orthographic projection of the second post spacer 242 on the first base substrate 11. A maximum length d3 in the first direction X of an orthographic projection of the first post spacer 241 on the first base substrate 11 is substantially equal to a maximum length d4 in the first direction X of an orthographic projection of the second post spacer 242 on the first base substrate 11. In some embodiments, when the orthographic projection of the first post spacer 241 on the first base substrate 11 has a shape of an ellipse, the maximum length d1 in the second direction Y of the orthographic projection of the first post spacer 241 on the first base substrate 11 may be understood as a length of a major axis of the ellipse. When the orthographic projection of the second post spacer 242 on the first base substrate 11 has a shape of an ellipse, the maximum length d2 in the second direction Y of the orthographic projection of the second post spacer 242 on the first base substrate 11 may be understood as a length of a major axis of the ellipse. In some embodiments, when the orthographic projection of the first post spacer 241 on the first base substrate 11 has a shape of an ellipse, the maximum length d3 in the first direction X of the orthographic projection of the first post spacer 241 on the first base substrate 11 may be understood as a length of a minor axis of the ellipse. The maximum length d4 in the first direction X of the orthographic projection of the second post spacer 242 on the first base substrate 11 may be understood as a length of a minor axis of the ellipse.

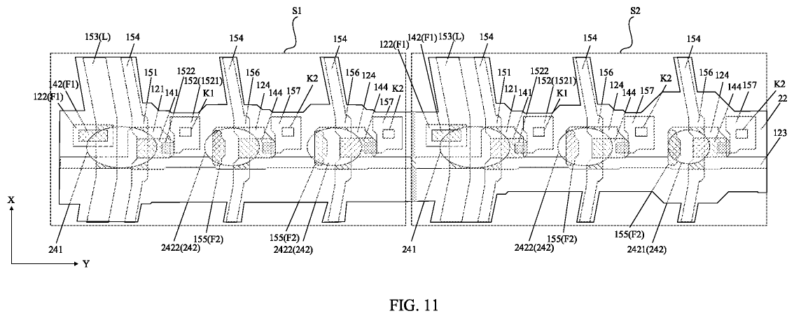

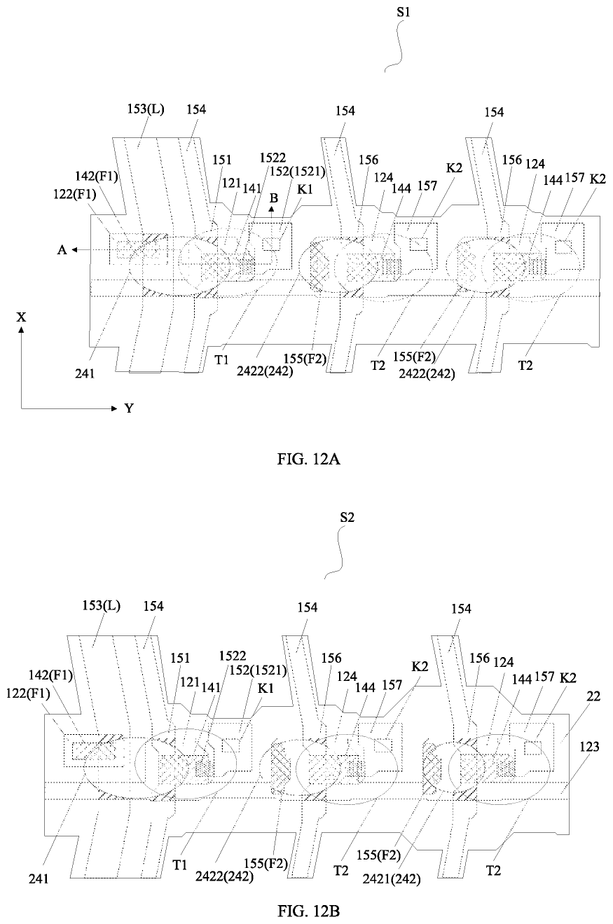

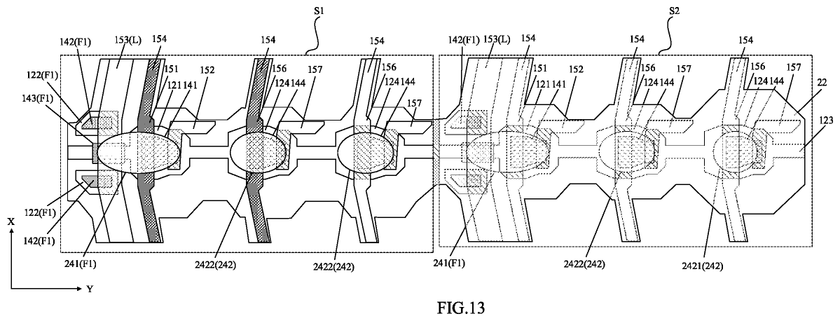

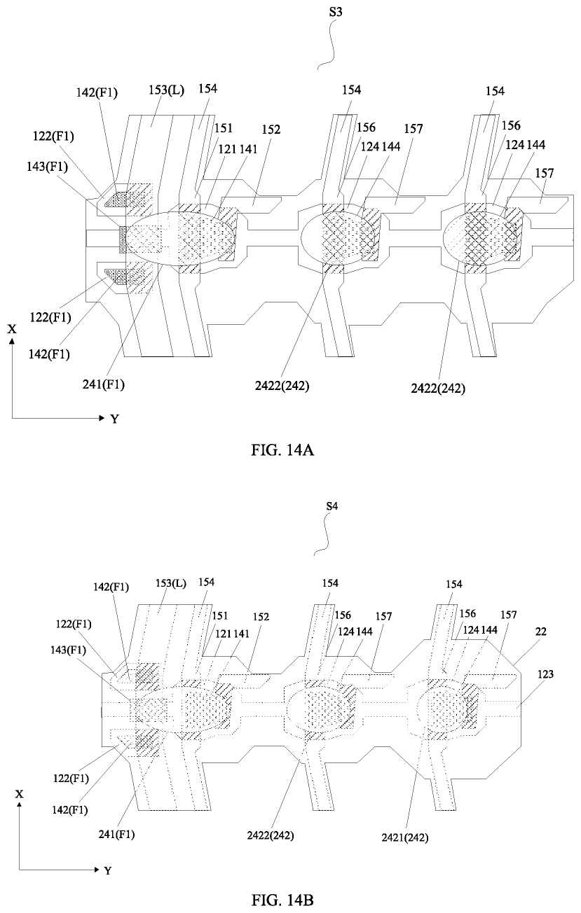

In some embodiments, among FIGS. 2A-2F, FIGS. 4A-4F, FIGS. 6A-6G, FIGS. 8A-8G, FIG. 11, FIG. 12A-12B, FIG. 13, and FIGS. 14A-14B, FIG. 11 is a schematic diagram of an arrangement of a plurality of first post spacers, first sub-post spacers and second sub-post spacers when a first thin-film transistor T1 is an oxide thin-film transistor, FIG. 12A is an enlarged schematic diagram at dotted line box S1 in FIG. 11, FIG. 12B is an enlarged schematic diagram at dotted line box S2 in FIG. 11, FIG. 13 is a schematic diagram of an arrangement of a first post spacer, a first sub-post spacer and a second sub-post spacer when a first thin-film transistor T1 is a polysilicon thin-film transistor, FIG. 14A is an enlarged schematic diagram at dotted line box S3 in FIG. 13, and FIG. 14B is an enlarged schematic diagram at dotted line box S4 in FIG. 13. The second post spacer 242 includes a first sub-post spacer 2421 and a second sub-post spacer 2422; and a height (not shown in the figure) of the first sub-post spacer 2421 in a direction perpendicular to the first base substrate 11 is greater than a height (not shown in the figure) of the second sub-post spacer 2422 in the direction perpendicular to the first base substrate 11, and the height (not shown in the figure) of the first sub-post spacer 2421 in the direction perpendicular to the first base substrate 11 is greater than a height (not shown in the figure) of the first post spacer 241 in the direction perpendicular to the first base substrate 11.

In some embodiments, an orthographic projection of the first sub-post spacer 2421 on the first base substrate 11 may have a shape of an ellipse, a circle, a quadrilateral, a pentagon, a hexagon or an octagon, and an orthographic projection of the second sub-post spacer 2422 on the first base substrate 11 may have a shape of an ellipse, a circle, a quadrilateral, a pentagon, a hexagon or an octagon.

In some embodiments, the first sub-post spacer 2421 may be a main post spacer (Main PS), and the second sub-post spacer 2422 and the first post spacer 241 may both be sub-post spacers (Sub PS). In some embodiments, the display panel includes a surface film layer on the first base substrate 11, where a distance between the surface film layer and the first base substrate 11 is greater than a distance between the remaining film layer on the first base substrate 11 and the first base substrate 11; that is, the surface film layer may be a film layer arranged on a top surface of the first base substrate 11. For example, the surface film layer may be an alignment film (not shown in the figure) for aligning liquid crystals. A first gap is provided between the first post spacer 241 and the surface film layer, a second gap is provided between the second sub-post spacer 2422 and the surface film layer, and the first sub-post spacer 2421 is in contact with the surface film layer, that is, the first sub-post spacer 2421 may be in contact with the surface film layer provided on the first base substrate 11, and the gap may be provided between each of the first sub-post spacer 241 and the second sub-post spacer 2422, and the surface film layer on the first base substrate 11.

In some embodiments, as shown in FIG. 11 and FIGS. 12A-12B, the first sub-post spacer 2421 may be located in a region without a touch line 153, so as to avoid the condition that when the first post spacer 241 be in contact with the surface film layer of the first base substrate 11, the second drain electrode 157 of the second thin-film transistor T2 and the pixel electrode (the second electrode 19) need to be in communication through a second via hole K2, such that the first sub-post spacer 2421 may damage the second via hole K2, and affects the conduction between the second drain electrode 157 and the pixel electrode.

In some embodiments, as shown in FIG. 11, FIG. 12A-FIG. 12B, FIG. 13, and FIG. 14A-FIG. 14B, a distribution density of the main post spacer (the first sub-post spacer 2421) may be smaller than a distribution density of the sub-post spacers (the first post spacer 241 and the second sub-post spacer 2422). In some embodiments, one main post spacer (the first sub-post spacer 2421) may be arranged at an interval of a plurality of sub-post spacers (the first post spacer 241 and the second sub-post spacer 2422) that are continuously arranged. In some embodiments, for example, the ratio of the distribution density of the main post spacer (the first sub-post spacer 2421) to the distribution density of the sub-post spacers (the first post spacer 241 and the second sub-post spacer 2422) may fall within 1/84-10/84. In some embodiments, for example, if the total number of the main post spacers (the first sub-post spacer 2421) and the sub-post spacers (the first post spacer 241 and the second sub-post spacer 2422) is 84 as a setting period, the number of main post spacers (the first sub-post spacer 2421) may be set to 4, and the number of the sub-post spacers (the first post spacer 241 and the second sub-post spacer 2422) may be set to 80. In the 80 sub-post spacers (the first post spacer 241 and the second sub-post spacer 2422), the number of first post spacer 241 may be set to 28, and the number of the second sub-post spacer 2422 may be set to 52.

In some embodiments, as shown in FIGS. 2A-2F, FIGS. 4A-4F, FIGS. 6A-6F and FIGS. 8A-8F, a maximum length d21 in the second direction Y of an orthographic projection of the first sub-post spacer 2421 on the first base substrate 11 is smaller than a maximum length d22 in the second direction Y of an orthographic projection of the second sub-post spacer 2422 on the first base substrate. In some embodiments, the maximum length d21 in the second direction Y of the orthographic projection of the first sub-post spacer 2421 on the first base substrate 11 may be understood as a length of a major axis of an ellipse. When the orthographic projection of the second post spacer 242 on the first base substrate 11 has a shape of an ellipse, the maximum length d22 in the second direction Y of the orthographic projection of the second sub-post spacer 2422 on the first base substrate 11 may be understood as a length of a major axis of the ellipse.

In some embodiments, a difference between the maximum length d1 in the second direction Y of the orthographic projection of the first post spacer 241 on the first base substrate 11 and the maximum length d22 in the second direction Y of the orthographic projection of the second sub-post spacer 2422 on the first base substrate 11 falls within 3 μm-10 μm. In some embodiments, the difference between the maximum length d1 in the second direction Y of the orthographic projection of the first post spacer 241 on the first base substrate 11 and the maximum length d22 in the second direction Y of the orthographic projection of the second sub-post spacer 2422 on the first base substrate 11 may be 3 μm, 4.5 μm, 5 μm, 6 μm, 7 μm, 8 μm, 9 μm or 10 μm. A difference between the maximum length d22 in the second direction Y of the orthographic projection of the second sub-post spacer 2422 on the first base substrate 11 and the maximum length d21 in the second direction Y of the orthographic projection of the first sub-post spacer 2421 on the first base substrate 11 falls within 2 μm-5 μm. A difference between the maximum length d22 in the second direction Y of the orthographic projection of the second sub-post spacer 2422 on the first base substrate 11 and the maximum length d21 in the second direction Y of the orthographic projection of the first sub-post spacer 2421 on the first base substrate 11 is 2 μm, 3 μm, 4 μm or 5 μm.

In some embodiments, the maximum length d1 in the second direction Y of the orthographic projection of the first post spacer 241 on the first base substrate 11 falls within 18 μm-24 μm. In some embodiments, the maximum length d1 in the second direction Y of the orthographic projection of the first post spacer 241 on the first base substrate 11 may be 18 μm, 19 μm, 20 μm, 21 μm, 22 μm, 23 μm or 24 μm. In some embodiments, the maximum length d22 in the second direction Y of the orthographic projection of the second sub-post spacer 2422 on the first base substrate 11 falls within 11 μm-17 μm. In some embodiments, the maximum length d22 in the second direction Y of the orthographic projection of the second sub-post spacer 2422 on the first base substrate 11 may be 11 μm, 12 μm, 13 μm, 14 μm, 15 μm, 16 μm or 17 μm. The maximum length d21 in the second direction Y of the orthographic projection of the first sub-post spacer 2421 on the first base substrate 11 falls within 7 μm-14 μm, specifically, 7 μm, 8 μm, 9 μm, 10 μm, 11 μm, 12 μm, 13 μm or 14 μm.

In some embodiments, the maximum length d3 in the first direction X of the orthographic projection of the first post spacer 241 on the first base substrate 11 falls within 8 μm-14 μm, the maximum length d4 in the first direction X of the orthographic projection of the second sub-post spacer 2422 on the first base substrate 11 falls within 8 μm-14 μm, and the maximum length d4 in the first direction X of the orthographic projection of the first sub-post spacer 2421 on the first base substrate 11 falls within 8 μm-14 μm. In some embodiments, the maximum length d3 in the first direction X of the orthographic projection of the first post spacer 241 on the first base substrate 11 may be 8 μm, 9 μm, 10 μm, 11 μm, 12 μm, 13 μm or 14 μm. In some embodiments, the maximum length d4 in the first direction X of the orthographic projection of the second sub-post spacer 2422 on the first base substrate 11 may be 8 μm, 9 μm, 10μm, 11 μm, 12μm, 13 μm or 14 μm. In some embodiments, the maximum length d4 in the first direction X of the orthographic projection of the first sub-post spacer 2421 on the first base substrate 11 may be 8 μm, 9 μm, 10 μm, 11 μm, 12 μm, 13 μm or 14 μm.

In some embodiments, the orthographic projection of the first sub-post spacer 2421 on the first base substrate 11 may have a shape of a circle. In some embodiments, the maximum length d21 in the second direction Y of the orthographic projection of the first sub-post spacer 2421 on the first base substrate 11 may be 11 μm, and the maximum length d4 in the first direction X of the orthographic projection of the first sub-post spacer 2421 on the first base substrate 11 may be 11 μm. In another impossible implementation mode, the orthographic projection of the first sub-post spacer 2421 on the first base substrate 11 may have a shape of an ellipse, as shown in FIGS. 6F, 7A and 8F, the maximum length d21 in the second direction Y of the orthographic projection of the first sub-post spacer 2421 on the first base substrate 11 may be 11 μm, and the maximum length d4 in the first direction X of the orthographic projection of the first sub-post spacer 2421 on the first base substrate 11 may be 10 μm.

In some embodiments, in some embodiments, as shown in FIGS. 6A and 6F, in the case that the first thin-film transistor T1 is in a structure of the oxide thin-film transistor, the maximum length d3 in the first direction X of the orthographic projection of the first post spacer 241 on the first base substrate 11 may be 12 μm, the maximum length d1 in the second direction Y of the orthographic projection of the first post spacer 241 on the first base substrate 11 may be 18.5 μm, the maximum length d4 in the first direction X of the orthographic projection of the second sub-post spacer 2422 on the first base substrate 11 may be 11 μm, and the maximum length d22 in the second direction Y of the orthographic projection of the second sub-post spacer 2422 on the first base substrate 11 may be 14 μm.

In some embodiments, in some embodiments, as shown in FIG. 7A, in the case that the first thin-film transistor T1 is in a structure of the polysilicon thin-film transistor, the maximum length d3 in the first direction X of the orthographic projection of the first post spacer 241 on the first base substrate 11 may be 11 μm, the maximum length d1 in the second direction Y of the orthographic projection of the first post spacer 241 on the first base substrate 11 may be 21 μm, the maximum length d4 in the first direction X of the orthographic projection of the second sub-post spacer 2422 on the first base substrate 11 may be 11 μm, and the maximum length d22 in the second direction Y of the orthographic projection of the second sub-post spacer 2422 on the first base substrate 11 may be 14 μm.

In some embodiments, as shown in FIGS. 8A and 8F, in the case that the first thin-film transistor T1 is a polysilicon thin-film transistor and the second elevation portion F2 is provided, the maximum length d3 in the first direction X of the orthographic projection of the first post spacer 241 on the first base substrate 11 may be 11 μm, the maximum length d1 in the second direction Y of the orthographic projection of the first post spacer 241 on the first base substrate 11 may be 21 μm, the maximum length d4 in the first direction X of the orthographic projection of the second sub-post spacer 2422 on the first base substrate 11 may be 11 μm, and the maximum length d22 in the second direction Y of the orthographic projection of the second sub-post spacer 2422 on the first base substrate 11 may be 18 μm.

In some embodiments, as shown in FIGS. 2A-2F, FIGS. 4A-4F, FIGS. 6A-6G and FIGS. 8A-8G, the orthographic projection of the first sub-post spacer 2421 on the first base substrate 11 and the orthographic projection of the second drain electrode 157 on the first base substrate 11 do not overlap each other.

In some embodiments, as shown in FIGS. 2A-2F, FIGS. 4A-4F, FIGS. 6A-6G and FIGS. 8A-8G, the second gate electrode 124 and the first gate electrode 121 are located in the same layer and made from the same material, the second active layer 144 and the first active layer 141 are located in the same layer and made from the same material, and the second source and drain electrode and the first source and drain electrode are located in the same layer and made from the same material.

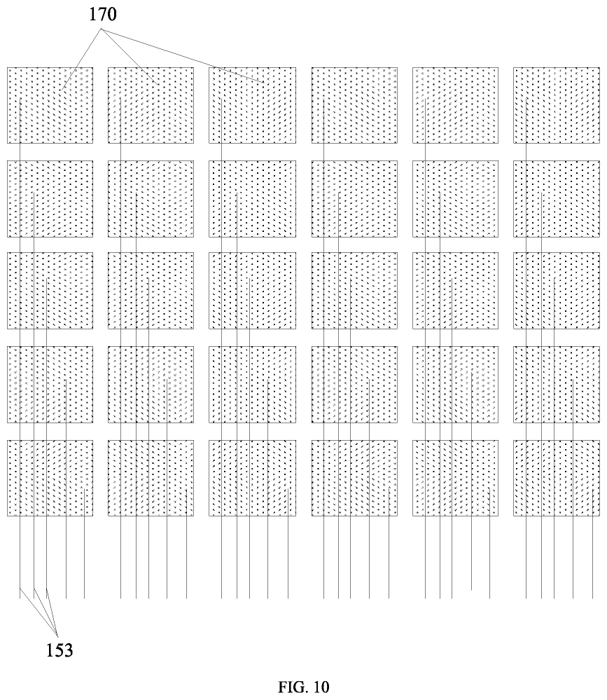

In some embodiments, as shown in FIG. 10, the common electrode layer is reused as a touch electrode layer and has a plurality of touch electrode blocks 170 that are insulated from each other. The touch line 153 and the touch electrode blocks 170 are in communicating connection in a one-to-one manner through via holes. It should be noted that FIG. 10 is merely a schematic description by taking a touch electrode layer including five rows and six columns of touch electrode blocks 170 as an example. During specific implementation, the touch electrode layer may also include multi-row and multi-column touch electrode blocks 170, which is not limited in the embodiment of the disclosure.

Based on the same inventive concept, Embodiments of the disclosure provide a display apparatus including the display panel according to the embodiment of the disclosure.

In the embodiment of the disclosure, the orthographic projection of the first post spacer 241 on the first base substrate 11 has the overlapped area with the orthographic projection of the first thin-film transistor T1 on the first base substrate 11, and has the overlapped area with the orthographic projection of the first signal line L on the first base substrate 11. When the display panel is under pressure, a region of the first signal line L may also play a supporting role for the first post spacer 241, thereby improving compression resistance of the display panel without losing an aperture ratio.

Although preferred embodiments of the disclosure have been described, a person of ordinary skill in the art can make additional changes and modifications to these embodiments once learning the basic inventive concept. Therefore, the appended claims are intended to be constructed as including the preferred embodiments and all modifications and changes falling within the scope of the disclosure.

Apparently, a person of ordinary skill in the art can make various modifications and variations to the embodiments of the disclosure without departing from the spirit and scope of the embodiments of the disclosure. In this way, if these modifications and variations of the embodiments of the disclosure fall within the scope of the claims of the disclosure and their equivalent arts, the disclosure is also intended to include these modifications and variations.

1. A display panel, comprising:
a first base substrate;
a plurality of first thin-film transistors located at a side of the first base substrate;
a first signal line located at a side of the first thin-film transistor
a second base substrate; and
a plurality of first post spacers located at a side of the second base substrate facing the first base substrate;
wherein an orthographic projection of the first post spacer on the first base substrate has an overlapped area with an orthographic projection of the first thin-film transistor on the first base substrate, and has an overlapped area with an orthographic projection of the first signal line on the first base substrate; and
a data line, a touch line and a gate line on the first base substrate;
wherein the gate line extends in a second direction which intersects with a first direction, and the first signal line is the touch line.

2. (canceled)

3. The display panel according to claim 1, wherein the first thin-film transistor comprises a first gate electrode, a first active layer, and a first source and drain electrode that are stacked, the first source and drain electrode comprising a first source electrode integrally connected with the data line and a first drain electrode spaced from the first source electrode; and
an orthographic projection of a partial outer boundary of the first signal line facing away from the first drain electrode on the first base substrate is located within the orthographic projection of the first post spacer on the first base substrate.

4. The display panel according to claim 1, further comprising:
at least one first elevation portion on the first base substrate;
wherein an orthographic projection of the first elevation portion on the first base substrate has an overlapped area with the orthographic projection of the first signal line on the first base substrate, and has an overlapped area with the orthographic projection of the first post spacer on the first base substrate.

5-7. (canceled)

8. The display panel according to claim 4, wherein the first gate electrode protrudes from a side of the gate line close to the first drain electrode; and
the first elevation portion and the first gate electrode are located at a same side of the gate line, and a gap is provided between the orthographic projections of the first elevation portion and the gate line on the first base substrate.

9. The display panel according to claim 4, wherein the first gate electrode protrudes from two sides of the gate line in the first direction; and
the first elevation portions are distributed at two sides of the gate line, and a gap is provided between each of the orthographic projections of the first elevation portions at different sides and the gate line on the first base substrate.

10. The display panel according to claim 8, wherein the first elevation portion comprises first floating metal and a first floating pattern at a side of the first floating metal facing away from the first base substrate; and
the first floating metal and the first gate electrode are located in a same layer and made from a same material, and the first floating pattern and the first active layer are located in a same layer and made from a same material.

11. The display panel according to claim 10, wherein an orthographic projection of the first floating metal on the first base substrate has a larger area than an orthographic projection of the first floating pattern on the first base substrate; and
the orthographic projection of the first floating metal on the first base substrate covers the orthographic projection of the first floating pattern on the first base substrate.

12. The display panel according to claim 3, further comprising:
a plurality of second thin-film transistors on the first base substrate;
a second elevation portion at a side of the second thin-film transistor; and
a plurality of second post spacers at the side of the second base substrate facing the first base substrate;
wherein an orthographic projection of the second post spacer on the first base substrate has an overlapped area with an orthographic projection of the second thin-film transistor on the first base substrate, and has an overlapped area with an orthographic projection of the second elevation portion on the first base substrate.

13. The display panel according to claim 12, wherein the second thin-film transistor comprises a second gate electrode, a second active layer, and a second source and drain electrode that are stacked, the second source and drain electrode comprising a second source electrode integrally connected with the data line and a second drain electrode spaced from the second source electrode; and
the second elevation portion and the second drain electrode are located at different sides of the data line.

14. The display panel according to claim 13, wherein the orthographic projection of the second elevation portion on the first base substrate is located within an orthographic projection of the second gate electrode on the first base substrate.

15. The display panel according to claim 13, wherein the second elevation portion comprises a second floating metal, and the second floating metal and the second source and drain electrode are located in a same layer and made from a same material; wherein the second elevation portion further comprises a second floating pattern, and the second floating pattern and the second active layer are located in a same layer and made from a same material.

16. (canceled)

17. The display panel according to claim 12, wherein an edge of the second source electrode facing away from the second drain electrode is a straight line; and
an outer boundary of the second elevation portion facing the second source electrode is a straight line.

18. The display panel according to claim 12, wherein a side of the second source electrode facing away from the second drain electrode is provided with a concave portion; and
an outer boundary of the second elevation portion facing the second source electrode is provided with a convex portion.

19. The display panel according to claim 12, wherein the orthographic projection of the second gate electrode on the first base substrate has an overlapped area with the orthographic projection of the second elevation portion on the first base substrate.

20. The display panel according to claim 12, wherein the orthographic projection of the second elevation portion on the first base substrate is located within the orthographic projection of the second gate electrode on the first base substrate; and
at least part of the orthographic projection of the second source electrode on the first base substrate is located within the orthographic projection of the second gate electrode on the first base substrate.

21. The display panel according to claim 12, wherein a maximum length in the second direction of the orthographic projection of the first post spacer on the first base substrate is greater than a maximum length in the second direction of the orthographic projection of the second post spacer on the first base substrate; and
a maximum length in the first direction of the orthographic projection of the first post spacer on the first base substrate is substantially equal to the maximum length in the second direction of the orthographic projection of the second post spacer on the first base substrate.

22. The display panel according to claim 13,
wherein the second post spacer comprises a first sub-post spacer and a second sub-post spacer; and
a height of the first sub-post spacer in a direction perpendicular to the first base substrate is greater than a height of the second sub-post spacer in the direction perpendicular to the first base substrate, and the height of the first sub-post spacer in the direction perpendicular to the first base substrate is greater than a height of the first post spacer in the direction perpendicular to the first base substrate.

23. The display panel according to claim 22, further comprising:
a surface film layer on the first base substrate, wherein a distance between the surface film layer and the first base substrate is greater than a distance between remaining film layers on the first base substrate and the first base substrate; and
a first gap is provided between the first post spacer and the surface film layer, a second gap is provided between the second sub-post spacer and the surface film layer, and the first sub-post spacer is in contact with the surface film layer.

24. The display panel according to claim 22, wherein a length in the second direction of an orthographic projection of the first sub-post spacer on the first base substrate is smaller than a length in the second direction of an orthographic projection of the second sub-post spacer on the first base substrate.

25-29. (canceled)

30. A display apparatus, comprising the display panel according to claim 1.
